(19) United States
(12) Patent Application Publication
(10) Pub. No.: US 2017/0141912 A1
(43) Pub. Date: May 18, 2017

(54) METHOD FOR PROTECTING A COMPUTER SYSTEM FROM SIDE-CHANNEL ATTACKS

(71) Applicant: Siemens AG Oesterreich, Wien (AT)

(72) Inventors: Christian CECH, Ebreichsdorf (AT); Martin MATSCHNIG, Tulln (AT); Ciprian-Leonard PITU, Brasov (RO)

(21) Appl. No.: 15/347,299

(22) Filed: Nov. 9, 2016

(30) Foreign Application Priority Data
Nov. 18, 2015 (AT) A50980/2015

(51) Int. Cl. H04L 9/00; H04L 9/06

(52) U.S. Cl. CPC H04L 9/003; H04L 9/065; H04L 2209/08

(57) ABSTRACT

A method for protecting a computer system from side-channel attacks when using an encryption or decryption method for data packets of a data stream, wherein interruptions in the encryption or decryption method are generated by a random generator, where further computing operations are applied during the interruptions to already encrypted or decrypted data packets of the data stream or to data packets of the data stream which are yet to be encrypted or decrypted to generate random noise in the power consumption of the computer system.

### BACKGROUND OF THE INVENTION

1. Field of the Invention

The invention relates to a computer system, a computer program product and a method for protecting a computer system from side-channel attacks when using an encryption or decryption method for data packets of a data stream, where interruptions in the encryption or decryption method are generated by a random generator.

2. Description of the Related Art

Encryption and error correction (for example, via an error-correcting code (ECC)) are two central mechanisms that are used in most computer system communications protocols. These two operations are generally independent of one another and are executed sequentially. In other words, data packets are first encrypted and the encoded data are additionally secured by an error-correcting code prior to transmission. On receipt, any transmission errors are generally first corrected, after which the data are decrypted. Combined methods are, however, also known, but are not widespread.

In modern security-critical applications, “side-channel attacks” (SCA) or differential power analysis (DPA) attacks pose an ever greater risk. The principle of such attacks is to record the power consumption of a computer system over a large number of cycles to draw conclusions about its inner workings. Cryptographic keys, for example, can be identified by this procedure. Whether, or how easily an attacker can achieve their objective with SCA, is dependent on the physical implementation of a cryptographic function.

A number of hardening measures are available for countering this risk. One widespread method is to introduce an additional logic circuit that is operated by a random generator. Alternatively, random empty cycles can be introduced, which of course extends run time. The stated measures disguise the power consumption of the computer system circuit by additional noise, which complicates DPA analyses. Accordingly, “hardened” cryptocores together with an error-correction logic circuit are generally required for secure transmission of encrypted content. In other words, the hardening mechanisms require additional hardware, or chip area, or also computing time.

These sometimes highly computing-intensive operations have previously either been reproduced in software or implemented by dedicated hardware modules. The former case requires processor computing time, i.e., CPU computing time, for the computation, and both cases generate additional data transfer.

### SUMMARY OF THE INVENTION

It is an object of the present invention to provide a method for protecting a computer system from side-channel attacks when using an encryption or decryption method for data packets of a data stream, which method requires no or as little additional CPU computing time as possible and does not require additional hardware.

This and other objects and advantage are achieved in accordance with the invention by a method in which interruptions in an encryption or decryption method are generated by a random generator. In accordance with the invention, further computing operations are applied during the interruptions to already encrypted or decrypted data packets of the data stream or to data packets of the data stream which are yet to be encrypted or decrypted in order to generate random noise in the power consumption of the computer system. Here, the further computing operations may preferably form part of an error-correcting method. The further computing operations may also, additionally or alternatively, form part of other sequential methods that are in any event provided, such as part of an algorithm for message authentication via a message authentication code (MAC) to mask the encryption or decryption operation.

The purpose of a message authentication code (MAC) is to obtain certainty about the origin of data or messages and to verify their integrity. MAC algorithms require two input parameters, firstly the data to be protected and secondly a secret key and, based on these, calculate a checksum, the message authentication code. The sender and receiver agree a secret key for this purpose. The sender calculates a MAC for this key and the message, and then sends the message and MAC to the receiver. The receiver calculates the MAC for the received message using the key and compares the calculated MAC with the received MAC. Matching of the two values is interpreted by the receiver as a successful integrity test, i.e., the message was dispatched by a party, who knows the secret key, and the message has not been modified during transmission. MACs are based either on block ciphers or on hash functions or are specially developed MACs. One common MAC calculation method, HMAC, is based on cryptographic hash functions.

The described invention thus combines encryption with other operations, generally with error correction, such that the further necessary computing operations are utilized to ensure random noise in the power consumption of the overall system. To this end, the two operations (encryption and the other operation) are, as previously, executed one after the other in accordance with a pipeline principle. A random generator generates a random number that is used in the encryption or decryption unit to introduce interruptions in the form of empty cycles at random points in time in the encryption or decryption process.

In the case of encryption, the data stream is ideally subjected firstly to the encryption method and then subjected to the further computing operations, in particular the error-correction method. In the case of decryption, the data stream is subjected firstly to the further computing operations, in particular the error-correction method, and then subjected to the decryption method.

“Error-correcting code” (ECC) methods may be used as the error-correction method. An error-correcting code method is an algorithm for expressing a sequence of numbers such that any errors that occur in the sequence can later be identified and, within limits, corrected based on the remaining numbers. In the error-correcting code method, the emphasis is on safeguarding against randomly occurring bit errors, such as due to radiation.

In a simple embodiment the method in accordance with the invention, the start and finish of the further computing operations is controlled by the encryption or decryption method. This means that, for instance, the ECC generator, which generates the error-correcting code, is controlled by the encryption unit such that it only operates during the empty cycles of the encryption unit.

In the rare case that the further computing operations, such as error-correction, are already complete while encryption or decryption is still executing empty cycles, the ECC generator (or, in the case of decryption, the decryption unit) operate with random input data for this period. Here, the present embodiment invention may provide that, if the further computing operations are finished, but the encryption or decryption method has not yet finished, the interruptions generated by the encryption or decryption method are filled with computing operations based on random data.

An error-correction method may, for instance, be performed with random data that are generated by the random generator that also generates the interruptions for the encryption or decryption method.

The method in accordance with the disclosed embodiments of the invention is particularly suitable for use in security-related embedded systems. An embedded system is an electronic computing element or computer that is incorporated (embedded) in an industrial context. Here, the computer assumes, for instance, monitoring or open- or closed-loop control functions or is responsible for a form of data or signal processing. A hybrid hardware-software implementation, which combines the great flexibility of software with the performance of hardware, is usually selected for this purpose. Here, the software serves both for control of the embedded system itself as well as optionally for interaction of the embedded system with the external world via defined interfaces or protocols.

A computer system for performing the method in accordance with the invention comprises at least one encryption or decryption unit, a further computing unit arranged serially thereto with respect to a data stream and a random generator that is configured to generate interruptions in the encryption or decryption method in the encryption or decryption unit. Here, the encryption or decryption unit is connected to the further computing unit such that, during the interruptions, the further computing unit applies further computing operations to already encrypted or decrypted data packets of the data stream or to data packets of the data stream which are yet to be encrypted or decrypted.

The random generator may be connected to the further computing unit such that, in the event that the further computing operations are finished, but the encryption or decryption method is not yet finished, the interruptions generated by the encryption or decryption method are filled with computing operations of the further computing unit based on random data from the random generator.

The computer system in accordance with the invention may be formed as an application-specific integrated circuit (ASIC). It may, however, also be formed as a field-programmable gate array (FPGA), i.e., a digital computation integrated circuit (IC), in which a logic circuit can be programmed. In both cases, the computer system in accordance with the invention may be produced as a single-chip system or a system-on-chip (SoC).

The computer system may, for example, be formed as a field-programmable gate array (FPGA) and the encryption or decryption unit and further computing unit may be formed as a soft core or hard core.

Soft cores comprises source code or a netlist and are implemented in the freely programmable region of an FPGA. Soft cores thus correspond to the soft IP in ASICs. An IP core that comprises source code may be used for both FPGAs and ASICs. Soft cores that comprises a netlist, in contrast, can only be used with a specific FPGA model.

Hard cores are unmodifiably integrated into the FPGA chip by the manufacturer as a finished circuit. The advantage of this is that hard cores occupy less chip area and are usually also capable of running faster than soft cores implemented with a freely programmable logic circuit. Drawbacks are the lack of any possibility of making custom adaptations or porting (migration) to other logic families, which do not have the usually very specific hard cores.

The invention may, for instance, when using soft cores in FPGAs or ASICs, be realized using a computer program. A computer program product is accordingly provided which comprises a program which can be directly loaded into the computing unit of a computer system, having program instructions or program code for executing the steps of the method in accordance with the invention when the program is executed by the computing unit.

Hardening against differential power analysis (DPA) attacks can be achieved by the method in accordance with the disclosed embodiments of the invention without additional hardware or computing time. As a result, additional chip area is not required, whereby the overall chip can be manufactured more inexpensively. Additional power consumption is minimized because it is only in exceptional cases that additional computing operations with random input data are performed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following part of the description explains the invention in greater detail with reference to the figure, from which further advantageous refinements, details and further developments of the invention may be inferred, in which:

FIG. 1 shows a schematic block diagram of part of a computer system according to the invention, where only those units of the computer system which are essential to the invention are shown, and further units, such as processors, input/output units, controllers, additional interfaces, storage devices, etc. may be and generally are present; and

FIG. 2 is a flowchart of the method in accordance with the invention.

### DETAILED DESCRIPTION OF THE EXEMPLARY EMBODIMENTS

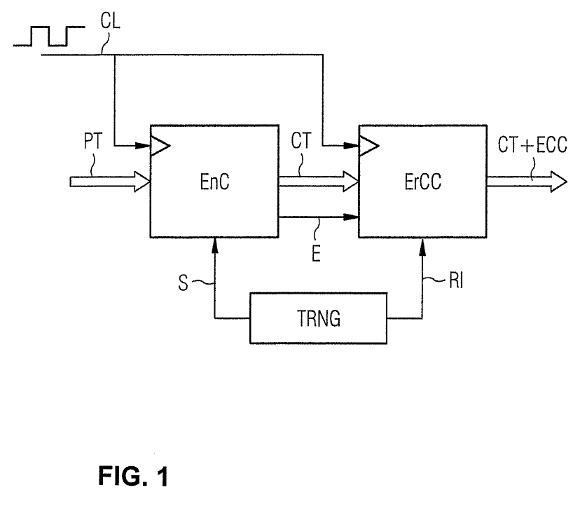

FIG. 1 should be considered exemplary and, while being intended to represent the nature of the invention, is not intended to restrict it or reproduce it exhaustively.

FIG. 1 shows only two computing units as part of the computer system, i.e., an encryption unit EnC, which is also designated encryption core, a further computing unit, which here, comprises an error-correction unit ErCC and is also designated error-correction core, and a random number generator TRNG. The computer system for decryption generally has two further corresponding computing units, a further error-correction unit ErCC and a decryption unit, where the error-correction unit ErCC is passed through first and then the decryption unit during decryption of the data. These two computing units for decryption may again be formed in accordance with the invention, with a dedicated random number generator TRNG. It would also be conceivable for the units shown in the FIG. 1, i.e., the encryption unit EnC, the error-correction unit ErCC and the random number generator TRNG, to optionally also to perform decryption. Here, data flow would be in the other direction, i.e., the data would thus first pass into the error-correction unit ErCC and only subsequently into the encryption unit EnC that is in this case operating as a decryption unit.

The encryption unit EnC (or decryption unit) and error-correction unit ErCC may each comprise a hard or soft core, while the computer system itself may comprise an application-specific integrated circuit (ASIC) or field-programmable gate array (FPGA).

The random number generator (TRNG) (true random number generator) is a physical random number generator that utilizes physical processes for number generation. Pulse fluctuations in electronic circuits (for example, thermal noise from a resistor) are utilized for this purpose. In general, it is possible to use not only any natural sources that are based on physical effects and deliver very high quality, but also other asynchronous sources, such as atmospheric noise, CCD sensor noise, the fluctuation in the actual duration of a period of time measured with a timer or voltage fluctuations at a Zener diode.

The data stream now passes as an unencrypted data stream (plaintext) PT into the encryption unit EnC, where it is encrypted and exits the encryption unit EnC as an encrypted data stream (ciphertext) CT. The ciphertext is supplied to the error-correction unit ErCC, which creates the error-correcting code ECC for it and forwards the code together with the encrypted data stream CT, outwards, such as by radio transmission or via electrical or optical lines.

The same clock signal CL is supplied both to the encryption unit EnC and to the error-correction unit ErCC for synchronization, where one cycle corresponds to an execution cycle or an idle cycle. The random number generator TRNG now generates, based on the random numbers it has generated, a signal S that causes an interruption of the encryption method in the encryption unit EnC. The encryption unit EnC then sends a switching signal (enable) E to the error-correction unit ErCC, which starts the error-correction method. Once the specified duration of the interruption to the encryption method has finished, the switching signal E is switched off, finishing error correction until further notice and the encryption method restarts. Encryption is then not re-interrupted until the random number generator specifies a new interruption.

Once the encryption method for a specified portion of the data stream is complete, error correction may be executed to completion without further interruptions for this portion.

Should the error-correction method for a specified portion of data stream be completed before encryption is finished, the encryption method would no longer be masked. Accordingly, in the event that the error-correction method is finished, but the encryption method is not yet complete, the error-correction method must continue to be operated based on the random data (random input) RI during the interruptions in the encryption method. The random data RI for this purpose are generated by the random number generator TRNG and supplied to the error-correction unit ErCC. While the resultant error-correction code ECC is indeed generated, in order to generate the desired noise, it is not transmitted onward.

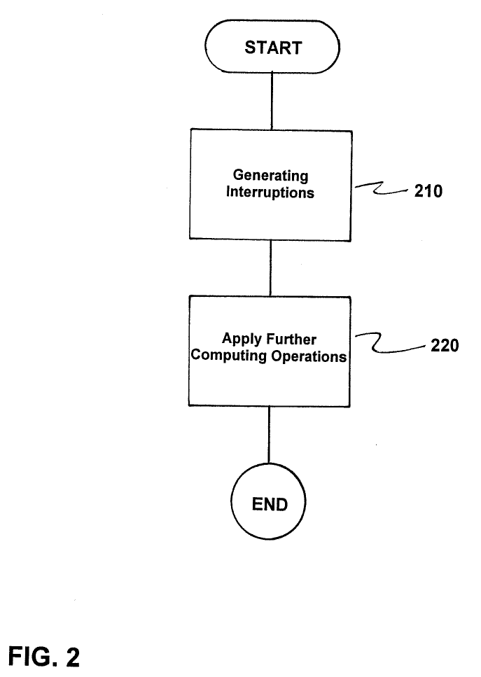

FIG. 2 is a flowchart of the method for protecting a computer system from side-channel attacks when using an encryption or decryption method for data packets of a data stream (PT). The method comprises generating interruptions in the encryption or decryption method via a random generator (TRNG), as indicated in step 210. Next, further computing operations are applied to already encrypted or decrypted data packets of the data stream or to data packets of the data stream which are yet to be encrypted or decrypted during the generated interruptions to generate random noise in power consumption of the computer system, as indicated in step 220.

Thus, while there have shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for protecting a computer system from side-channel attacks when using an encryption or decryption method for data packets of a data stream, the method comprising:
generating interruptions in the encryption or decryption method via a random generator; and
applying further computing operations to already encrypted or decrypted data packets of the data stream or to data packets of the data stream which are yet to be encrypted or decrypted during the generated interruptions to generate random noise in power consumption of the computer system.

2. The method as claimed in claim 1, wherein the further computing operations are part of an error-correction method.

3. The method as claimed in claim 1, wherein the further computing operations are part of an algorithm for message authentication via a message authentication code.

4. The method as claimed in claim 2, wherein the further computing operations are part of an algorithm for message authentication via a message authentication code.

5. The method as claimed in claim 1, wherein, in cases of encryption, the data stream is initially subjected to the encryption method and then subjected to the further computing operations.

6. The method as claimed in claim 2, wherein, in cases of encryption, the data stream is initially subjected to the encryption method and then subjected to the further computing operations.

7. The method as claimed in claim 3, wherein, in cases of encryption, the data stream is initially subjected to the encryption method and then subjected to the further computing operations.

8. The method as claimed in claim 5, wherein the further computing operations comprise an error-correction method.

9. The method as claimed in claim 1, wherein, in cases of decryption, the data stream is subjected initially subjected to the further computing operations and then subjected to the decryption method.

10. The method as claimed in claim 2, wherein, in cases of decryption, the data stream is subjected initially subjected to the further computing operations and then subjected to the decryption method.

11. The method as claimed in claim 3, wherein, in cases of decryption, the data stream is subjected initially subjected to the further computing operations and then subjected to the decryption method.

12. The method as claimed in claim 5, wherein the further computing operations comprise an error-correction method.

13. The method as claimed in one of claim 1, wherein a start and finish of the further computing operations are controlled by the encryption or decryption method.

14. The method as claimed in claim 1, wherein, if the further computing operations are finished, but the encryption or decryption method is unfinished, the interruptions generated by the encryption or decryption method are filled with computing operations based on random data.

15. The method as claimed in claim 2, wherein an error-correction method is performed with random data which are generated by the random generator.

16. The method as claimed in claim 14, wherein an error-correction method is performed with random data which are generated by the random generator.

17. A computer system, comprising:
at least one encryption or decryption unit;
a further computing unit arranged in series with the at least one encryption or decryption unit with respect to a data stream; and
a random generator configured to generate interruptions in an encryption or decryption method in the encryption or decryption unit;
wherein the encryption or decryption unit is operatively connected to the further computing unit such that, during the interruptions, the further computing unit applies further computing operations to already encrypted or decrypted data packets of the data stream or to data packets of the data stream which are yet to be encrypted or decrypted.

18. The computer system as claimed in claim 17, wherein the random generator is operatively connected to the further computing unit such that, in an event that the further computing operations are completed, but the encryption or decryption method is not yet finished, the interruptions generated by the encryption or decryption method are filled with computing operations of the further computing unit based on random data from the random generator.

19. The computer system as claimed in claim 17, wherein the computer system comprises a field-programmable gate array and the encryption or decryption unit and further computing unit are formed as a soft core or hard core.

20. A non-transitory computer program product encoded with a program which is directly loadable into a computing unit of a computer system which, when executed by the computing unit, provides protection of the computer system from side-channel attacks when using an encryption or decryption method for data packets of a data stream, the computer program comprising:
program code generating interruptions in the encryption or decryption method via a random generator; and
program code for applying further computing operations to already encrypted or decrypted data packets of the data stream or to data packets of the data stream which are yet to be encrypted or decrypted during the generated interruptions to generate random noise in power consumption of the computer system.
